(19) United States
(12) Patent Application Publication
(10) Pub. No.: US 2013/0051000 A1
(43) Pub. Date: Feb. 28, 2013

(54) TRANSPARENT DISPLAY STRUCTURE

(71) Applicants: Sam YU, Taoyuan City (TW); Dalong Cheng, Taoyuan City (TW)

(72) Inventors: Sam YU, Taoyuan City (TW); Dalong Cheng, Taoyuan City (TW)

(21) Appl. No.: 13/402,597

(22) Filed: Feb. 22, 2012

(30) Foreign Application Priority Data
Aug. 26, 2011 (TW) 100216011

(51) Int. Cl. F21S 4/00

(52) U.S. Cl. 362/225

(57) ABSTRACT

A transparent display structure includes two transparent rigid base plates, a plurality of light strips arranged therebetween and an interlayer film disposed between the two transparent rigid base plates and light strips. The plurality of light strips may also be disposed on an inner surface of the one of the transparent rigid base plates, and the interlayer film be disposed on the peripheries of the inner surfaces of the two transparent rigid base plates facing against each other. The transparent display structure can be directly used as an external wall, an outdoor display board or an indoor display divider of the architectural field. Also, the transparent display structure is open to planar shape design and curved shape design, thereby having high application versatility.

### BACKGROUND OF THE INVENTION

1. Field of the Invention

The present invention relates to a display structure, and more particularly to a transparent display structure constructed by transparent rigid base plates holding a plurality of light strips therebetween.

2. Description of the Prior Art

Nowadays many buildings adopt transparent glass curtain for the sake of appearance and lighting. Installing a large-sized display board on the glass curtain to increase the added value of the building has become a new advertisement style trend. Conventionally, a large-sized display board such as an electronic LED display board uses various array arrangements of LEDs to achieve the effect of variable patterns or direct image play. However, such display board mostly requires additional installation work on the external portion of the glass curtain or cement wall and would incur higher installation cost. Also, the LEDs suffering from the exposure to the sun and rain of the external environment would inevitably be damaged or deteriorate, causing the life expectancy of the large-sized display board to be affected.

In another aspect, the conventional large-sized display board is constrained to be configured on the plane of the external wall of the building, and can only be designed as a flat board, which has limited style and little application versatility, and therefore has a low practical value.

### SUMMARY OF THE INVENTION

One object of the present invention is to provide a transparent display structure with high transparency and be directly used as an outdoor glass wall or an indoor display divider of the architectural field so that the construction of the glass wall can be finished at the same time the transparent display structure is installed, providing the benefit of low construction cost.

One object of the present invention is to provide a transparent display structure opening for planar or curved shape design, thereby affording high application versatility.

One object of the present invention is to provide a transparent display structure of which light strips are disposed inside a laminated glass or hollow glass, thereby being protected from water and dust and having higher stability.

According to an embodiment, the transparent display structure includes transparent rigid base plates spaced apart; a plurality of light strips arranged between the two transparent rigid base plates; and an interlayer film disposed between the two transparent rigid base plates and the light strips.

According to another embodiment, the transparent display structure includes two transparent rigid base plates spaced apart and having two inner surfaces facing against each other; a plurality of light strips arranged on one of the inner surfaces; and an interlayer film disposed on the peripheries of the two inner surfaces.

The foregoing aspects and the accompanying advantages of this invention will become more readily appreciated from the following detailed description taken in conjunction with the attached drawings.

### BRIEF DESCRIPTION OF THE DRAWINGS

FIG. 1 is a schematic structural diagram of the transparent display structure according to the first embodiment the present invention;

FIG. 2 is a schematic sectional diagram of the transparent display structure according to the first embodiment of the present invention;

FIG. 3 is a schematic structural diagram of the transparent display structure according to the second embodiment of the present invention; and

FIG. 4 is a schematic sectional diagram illustrating the transparent display structure according to the third embodiment of the present invention.

### DETAILED DESCRIPTION OF THE INVENTION

The examples described herein are provided merely for purposes of illustration and are not intended to limit embodiments of the present invention.

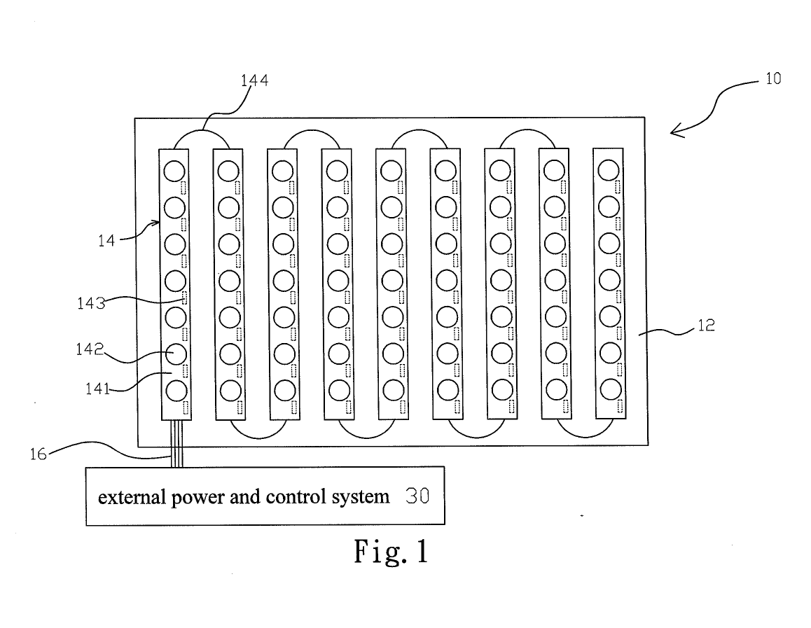

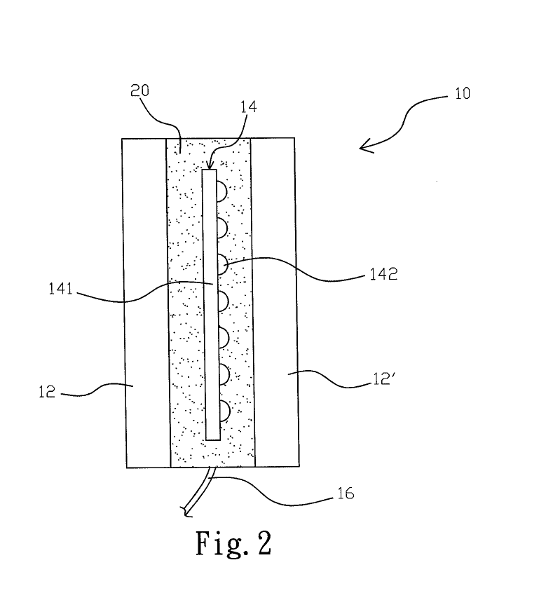

FIG. 1 is a schematic structural diagram of a transparent display structure according to a first embodiment. FIG. 2 is a schematic sectional diagram of the transparent display structure according to the first embodiment. Referring to FIG. 1 and FIG. 2, the transparent display structure 10 includes two transparent rigid base plates 12, 12′, a plurality of light strips 14 and an interlayer film 20. The two transparent rigid base plates 12, 12′ are configured spaced apart and parallel to each other. In this embodiment, the two transparent rigid base plates 12, 12′ are both flat boards. However, the present invention is not limited to be implemented in such way. The two transparent rigid base plates 12, 12′ may also be curved. The plurality of light strips 14 are arranged between the two transparent rigid base plates 12, 12′. The interlayer film 20 is disposed between the two transparent rigid base plates 12, 12′ and the plurality of light strips 14.

As illustrated in FIG. 1, the plurality of light strips 14 are electrically connected by a plurality of internal power and signal control wires 144 to each other, wherein a light strip 14 is electrically connected to an external power and control system 30 with an external power and control line group 16 to drive the plurality of the light strips 14 to emanate light. It is noted that the external power and control wire group 16 is not limited to be connected to the light strip 14 on the side, and it may connect electrically to any light strip 14 on the two sides or in the middle.

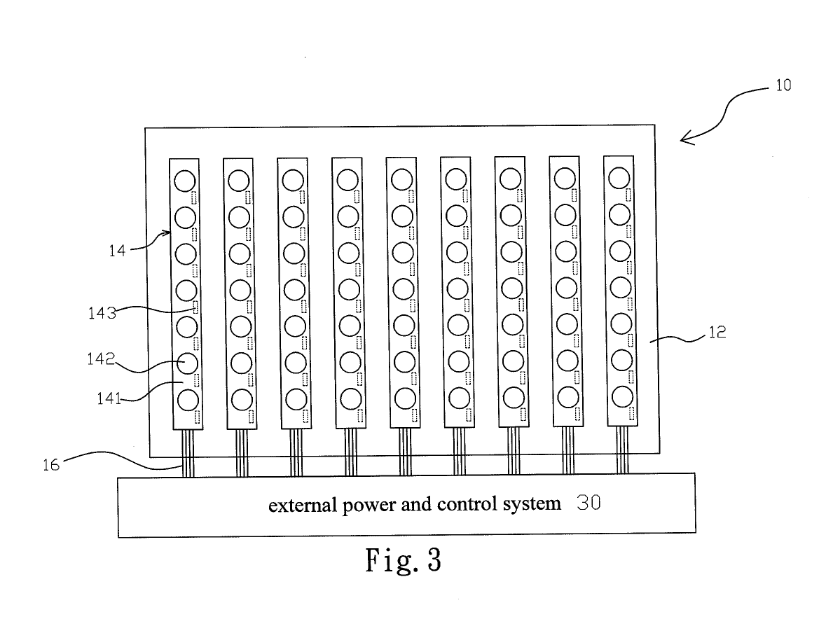

FIG. 3 is a schematic structural diagram of a transparent display structure according to a second embodiment. The difference between the second embodiment and the first embodiment is the way the light strips 14 are connected and controlled. As illustrated in FIG. 3, each light strip 14 is directly electrically connected to the external power and control system 30 through a respective external power and control wire group 16, so that the external power and control system 30 controls the light emission of the light strips 14, respectively.

As illustrated in FIG. 1 and FIG. 3, a plurality of light-emitting faces of the plurality of the light strips 14 are facing toward one of the transparent rigid base plates 12, and therefore the transparent display structure 10 displays brightness on one side. However, the present invention is not limited to be implemented in such way. According to another embodiment, the plurality of the light-emitting faces of the plurality of the light strips 14 may also selectively respectively facing toward the two transparent rigid base plates 12, 12′ according to needs, i.e. by rotating the directions of a portion of the light strips 14, the transparent display structure 10 can display brightness on both sides, enhancing flexibility for applications.

Continuing the above description, each light strip 14 includes a substrate 141, a plurality of light-emitting elements 142 and a plurality of electric elements 143. The substrate 141 can be a flexible circuit board, a printed circuit board or a non-flexible circuit board. The plurality of light-emitting elements 142 are disposed on the outer surface of the substrate 141. According to an embodiment, the light-emitting elements 142 can be monochromatic or color point controlled LEDs so that the light strips can have varying effects of color, text, images or animation. The plurality of electric elements 143 such as control ICs are disposed inside the substrate 141 or on an inner surface of the substrate 141 and electrically connecting the light-emitting elements 142. According to another embodiment, the control ICs may also be disposed inside the light-emitting elements 142.

The material of the transparent rigid base plates 12, 12′ can be but not limited to be glass, polycarbonate, plastic, laminated glass or laminated plastic. And the interlayer film can be but not limited to be polyvinyl butyral (PVB), ethylene naphthalate (EN), polyethylene naphthalate (PEN), ethyl vinyl acetate (EVA), poly urethane (PU), thermoplastic poly urethane (TPU) or adhesive gel. According to an embedment, the plurality of light strips 14 are held in the laminated glass formed by two transparent glasses and PVB, i.e. the light strips are fixed by glue injection. In the transparent display structure 10 formed by the laminated glass, area other than the area where the plurality of light strips 14 are disposed are transparent, providing great transparency and allowing the transparent display structure 10 of the present embodiment to have both the advantages of the color varying effect produced by the plurality of the light strips 10 and the transparency of the laminated glass. Moreover, using curved laminated glass affords the transparent display structure 10 high flexibility on shape design.

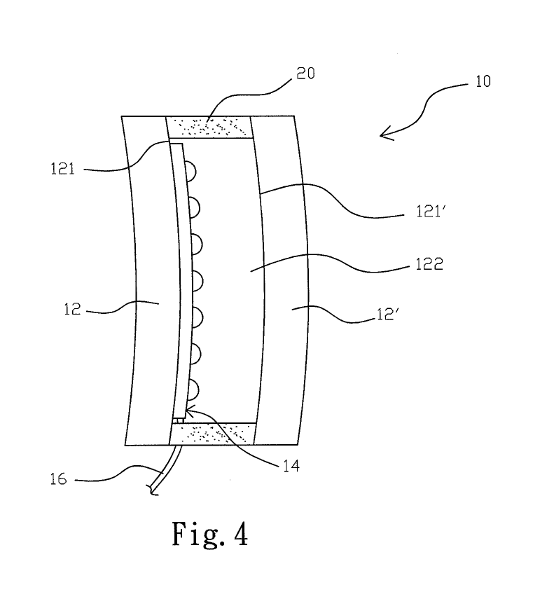

FIG. 4 is a schematic sectional diagram illustrating a transparent display structure according to a third embodiment. Referring to FIG. 4, the transparent display structure includes two transparent rigid base plates 12, 12′, a plurality of light strips 14 and an interlayer film 20. The transparent rigid base plates 12, 12′ are configured spaced apart and parallel to each other and having two inner surfaces 121, 121′ facing against each other. According to this embodiment, as illustrated in the figure, the two transparent rigid base plates 121, 121′ are curved for illustration purpose. However, the present invention is not limited to be implemented in such way. The two transparent rigid base plates 12, 12′ may also be planar. The plurality of light strips 14 are arranged on the inner surface 121 of one of the transparent rigid base plate 12. The interlayer film 20 is disposed on the peripheries of the two inner surfaces 121, 121′ so as to space apart the two transparent rigid base plates 12, 12′ and seal the hollow space 122 formed by the two transparent rigid base plates 12, 12′. The structure, connection and control mechanism of the light strips 14 have been provided in the first embodiment and are omitted to be described here.

Continuing the above description and taking the material of the transparent rigid base plates 12, 12′ to be glass as an example, the hollow glass formed by disposing the interlayer film 20 on the peripheries of the two inner surfaces 121, 121′ of the two transparent rigid base plates 12, 12′ as a spacer not only lowers the manufacturing cost of the transparent display structure 10 because the plurality of light strips 14 are directly disposed on the inner surface 121′ of the transparent rigid base plate 12, but also protects the light strips 14 from the attack of external moisture and extends the life expectancy of the light strips 14 because of the sealing effect of the interlayer film 20.

According to an embodiment, besides the design configuring the plurality of light strips in the laminated glass or hollow glass for the transparent display structure, two or more laminated glasses or hollow glasses may be overlapped, or the laminated glass and the hollow glass may be overlapped together to increase the thickness of the transparent display structure and create for the light strips a multi-layered visual effect. Further, in the transparent display structure, area other than the area where the plurality of light strips are disposed is transparent, providing good transparency.

According to the foregoing description, one spirit of the present invention lies in the provided transparent display structure can be adapted to the preference or need of a user on configuring different sizes, quantities or varieties of light-emitting elements of the light strips within the transparent rigid base plates, allowing more design flexibility. Furthermore, with the curved shape design, the transparent display structure may be applied to the transparent glass curtain and interior space divider of the architectural field; the display window, lamp design and desktop decoration of the furniture field; or display panel of illumination applications. In another aspect, whether the transparent display structure is formed by the aforementioned laminated glass, hollow glass or even composite glass, it is equipped to resist ultra violet (UV) rays and infrared (IR) rays. The light strips disposed inside the laminated glass or hollow glass are protected from water and dust and have higher stability. If LEDs are used for the light-emitting elements of the light strips, the transparent display structure would have a better energy saving effect. Compared to the plain planar display structure of the prior art, the transparent display structure of the present invention opening for planar or curved shape design provides high application versatility. Also, the high transparency of the transparent display structure allows it to be used directly as the glass wall of the architectural field, and therefore the construction of the glass wall can be finished at the same time the transparent display structure is installed, providing the benefit of low construction cost.

While the invention has been described with respect to particular embodiments and specific examples thereof, it should be understood that other embodiments may fall within the spirit and scope of the invention. The scope of the invention should, therefore, be determined from the appended claims along with their full scope of equivalents.

What is claimed is:

1. A transparent display structure, comprising:
two transparent rigid base plates spaced apart;
a plurality of light strips arranged between the two transparent rigid base plates; and
an interlayer film disposed between the two transparent rigid base plates and the light strips.

2. The transparent display structure according to claim 1, wherein each light strip comprises:
a substrate;
a plurality of light-emitting elements disposed on the substrate; and
a plurality of electric elements electrically connecting the light-emitting elements.

3. The transparent display structure according to claim 2, wherein the light-emitting element is a light-emitting diode (LED).

4. The transparent display structure according to claim 2, wherein the substrate is a flexible circuit board, a printed circuit board or a non-flexible circuit board.

5. The transparent display structure according to claim 1, wherein a plurality of the light-emitting faces of the light strips face toward one of the transparent rigid base plate.

6. The transparent display structure according to claim 1, wherein a plurality of the light-emitting faces of the light strips face toward the two transparent rigid base plates.

7. The transparent display structure according to claim 1, wherein the material of the two transparent rigid base plates is glass, polycarbonate, plastic, laminated glass or laminated plastic.

8. The transparent display structure according to claim 1, wherein the interlayer film is polyvinyl butyral (PVB), ethylene naphthalate (EN), polyethylene naphthalate (PEN), ethyl vinyl acetate (EVA), poly urethane (PU), thermoplastic poly urethane (TPU) or adhesive gel.

9. The transparent display structure according to claim 1, wherein the light strips are electrically connected by a plurality of internal power and signal control wires, and at least one of the light strips is electrically connected to an external power and control system on the outside with an external power and control wire group.

10. The transparent display structure according to claim 1, wherein each light strip is electrically connected to an external power and control system on the outside with a respective external power and control wire group.

11. The transparent display structure according to claim 1, wherein the two transparent rigid base plates are curved.

12. A transparent display structure, comprising:
two transparent rigid base plates spaced apart and having two inner surfaces facing against each other;
a plurality of light strips arranged on one of the inner surfaces; and
an interlayer film disposed on the peripheries of the two inner surfaces.

13. The transparent display structure according to claim 12, wherein each light strip comprises:
a substrate;
a plurality of light-emitting elements disposed on the substrate; and
a plurality of electric elements electrically connecting the light-emitting elements.

14. The transparent display structure according to claim 13, wherein the light-emitting element is a light-emitting diode (LED).

15. The transparent display structure according to claim 13, wherein the substrate is a flexible circuit board, a printed circuit board or a non-flexible circuit board.

16. The transparent display structure according to claim 12, wherein the material of the two transparent rigid base plates is glass, polycarbonate, plastic, laminated glass or laminated plastic.

17. The transparent display structure according to claim 12, wherein the interlayer film is polyvinyl butyral (PVB), ethylene naphthalate (EN), polyethylene naphthalate (PEN), ethyl vinyl acetate (EVA), poly urethane (PU), thermoplastic poly urethane (TPU) or adhesive gel.

18. The transparent display structure according to claim 12, wherein the light strips are electrically connected by a plurality of internal power and signal control wires, and at least one of the light strips is electrically connected to an external power and control system on the outside with an external power and control wire group.

19. The transparent display structure according to claim 12, wherein each light strip is electrically connected to an external power and control system on the outside with a respective external power and control wire group.

20. The transparent display structure according to claim 12, wherein the two transparent rigid base plates are curved.
